(19) United States
(12) Patent Application Publication
(10) Pub. No.: US 2018/0376408 A1
(43) Pub. Date: Dec. 27, 2018

(54) USER EQUIPMENT AND COMMUNICATION METHOD OF USER EQUIPMENT

(71) Applicant: Samsung Electronics Co., Ltd., Suwon-si, Gyeonggi-do (KR)

(72) Inventors: Jin RA, Suwon-si (KR); Chul-ho HAN, Seoul (KR); Seok-min OH, Seongnam-si (KR); Young-chan WOO, Suwon-si (KR); Seol-hye WON, Seoul (KR); Jin-young LEE, Suwon-si (KR)

(21) Appl. No.: 15/773,436

(22) PCT Filed: Apr. 4, 2016
(86) PCT No.: PCT/KR2016/003474

§ 371 Date: May 3, 2018

(30) Foreign Application Priority Data
Nov. 16, 2015 (KR) 10-2015-0160489

(51) Int. Cl. H04W 48/10; H04W 48/16

(52) U.S. Cl. CPC H04W 48/10; H04W 48/16

(57) ABSTRACT

Disclosed is a user equipment that supports device-to-device communication. A user equipment according to an embodiment of the present invention comprises: a communication unit for broadcasting a discovery message for informing another user equipment of the user equipment itself, and receiving a discovery message broadcasted from another user equipment; and a control unit for, when at least one discovery message is received, extracting an ID of at least one other user equipment from the at least one received discovery message, selecting at least one ID out of the extracted ID on the basis of status information indicating an importance of the at least one other user equipment, and broadcasting a discovery message including the selected ID.

### FIELD OF THE INVENTION

Devices and methods consistent with what is disclosed herein relate to a user equipment and a communication method of a user equipment, and more particular, to a user equipment that relays a discovery message of a user equipment that supports direct communication between equipments and a communication method of a user equipment for relay.

Recently, many ongoing efforts have been made to Proximity-based Service (ProSe) technology to facilitate direct communication between user equipments by using a conventional communication method of a mobile system without allowing a user equipment (UE) to access a network via higher-level entities than a base station.

Despite many possibilities to utilize the ProSe technology, the Device-to-Device communication between user equipments is difficult to ensure mobility of a user equipment unless a network on an upper node is not provided, so that there is limit on the possible range of communication.

### DESCRIPTION OF THE RELATED ART

One technical task of the present disclosure is to provide a user equipment for relaying a discovery message of a user equipment that supports direct communication between equipments and a communication method of a user equipment for relay.

### SUMMARY

According to an exemplary embodiment, there is provided a user equipment that supports direct communication between equipments including a communicator configured to broadcast a discovery message for informing another user equipment of the user equipment itself and receive a discovery message broadcasted from another user equipment, and a controller configured to, in response to at least one discovery message being received, extract at least one identification (ID) of another user equipment from the at least one received discovery message, select at least one ID from the at least one extracted ID based on status information indicating importance of the another user equipment, and broadcast a discovery message including the at least one selected ID.

The user equipment may further include a storage configured to store IDs of a plurality of user equipments constituting a group which is provided with service for the direct communication between equipments and status information respectively given to the IDs, wherein the controller is further configured to retrieve status information given to the at least one extracted ID in the storage and select at least one ID from the at least one extracted ID based on the retrieved status information.

The another user equipment may be given status information corresponding to one of a plurality of roles constituting a pre-arranged command system, and wherein the controller is further configured to select at least one ID from the at least one extracted ID based on whether the status information given to the another user equipment is status information corresponding to a role to be reported and ordered according to the command system.

The storage may be further configured to store ratings that indicate priorities of the status information given to the IDs, and wherein the controller is further configured to, in response to receiving a plurality of discovery messages, determine ratings of respective IDs extracted from the plurality of received discovery messages, and select at least one ID from the extracted IDs according to priorities of the determined ratings.

The controller may be further configured to modify the ratings stored in the storage based on at least one of status information of the another user equipment included in the received discovery message and status information of the user equipment itself.

The controller may be further configured to modify the ratings stored in the storage based on a state which enables communication via a network, a present time, integration with another group which is provided with the service for direct communication between equipments, and group division of the user equipments.

The controller may be further configured to broadcast a discovery message including another ID which is not broadcasted among the plurality of IDs at different periods according to the determined ratings.

The controller may be further configured to select IDs equal to or less than a predetermined number according to a size of a packet that is transmittable through the discovery message among the plurality of IDs based on the determined ratings, and in response to all of a plurality of IDs on a same rating not being transmitted through the discovery message, select a number of IDs which are transmittable through the discovery message based on a number of times each of the plurality of IDs on the same rating is relayed.

The controller may be further configured to extract at least one ID of another user equipment and relay information indicating a number of times the at least one ID is relayed from the received discovery message, broadcast a discovery message including at least one ID selected from the at least one extracted ID based on the status information and relay information obtained by adding a number of times the at least one selected ID is relayed once, and in response to a plurality of discovery messages including the same ID being received, broadcast a discovery message including the same ID based on a discovery message including relay information that indicates a fewest number of times of relays among the plurality of received discovery messages.

The user equipment may further include a display configured to display a screen, and an input unit configured to receive a user input, wherein the controller is further configured to display nodes indicating one or a plurality of user equipments which relay the at least one extracted ID and bridges indicating paths where the at least one extracted ID is relayed visually on the display, and in response to a user input selecting one or a plurality of nodes displayed on the display being received, create a channel for communication with another user equipment corresponding to the selected node.

According to an exemplary embodiment, there is provided a communication method of a user equipment that supports direct communication between equipments, the method may include receiving at least one discovery message broadcasted from another user equipment, extracting at least one ID of another user equipment from the at least one received discovery message, selecting at least one ID from the at least one extracted ID based on status information indicating importance of the another user equipment, and broadcasting a discovery message including the at least one selected ID.

The method may further include storing IDs of a plurality of user equipments constituting a group which is provided with service for direct communication between equipments and status information respectively given to the IDs, wherein the selecting comprises retrieving status information given to the at least one extracted ID, and selecting at least one ID from the at least one extracted ID based on the retrieved status information.

The another user equipment may be given status information corresponding to one of a plurality of roles constituting a pre-arranged command system, wherein the selecting comprises selecting at least one ID from the at least one extracted ID according to whether the status information given to the another user equipment is status information corresponding to a role to be reported and ordered according to the command system.

The storing may include storing ratings that indicate priorities of the status information given to the IDs, wherein the selecting comprises, in response to a plurality of discovery messages being received, determining ratings of respective IDs extracted from the plurality of received discovery messages, and selecting at least one ID from the extracted IDs according to priorities of the determined ratings.

The method may further include modifying the stored ratings based on status information of the another user equipment included in the received discovery message and status information of the user equipment itself.

The modifying may include modifying the stored ratings based on a state which enables communication via a network, a present time, integration with another group which is provided with the server for direct communication between equipments, and group division of the user equipments.

The broadcasting may include broadcasting a discovery message including another ID which is not broadcasted among the plurality of IDs at different periods according to the determined ratings.

The selecting may include selecting IDs equal to or less than a predetermined number according to a size of a packet that is transmittable through the discovery message among the plurality of IDs based on the determined ratings, and in response to all of a plurality of IDs on a same rating not being transmitted through the discovery message, selecting a number of IDs which are transmittable through the discovery message based on a number of times each of the plurality of IDs on the same rating is relayed.

The extracting may include extracting at least one ID of another user equipment and relay information indicating a number of times the at least one extracted ID is relayed from the received discovery message, wherein the broadcasting comprises broadcasting a discovery message including at least one ID selected from the at least one extracted ID based on the status information and relay information obtained by adding a number of times the at least one selected ID is relayed once, and in response to a plurality of discovery messages including the same ID being received, broadcasting a discovery message including the same ID based on a discovery message including relay information that indicates a fewest number of times of relays among the plurality of received discovery messages.

The communication method may further include displaying nodes indicating one or a plurality of user equipments which relay the at least one extracted ID and bridges indicating paths where the at least one extracted ID is relayed visually on the display, and in response to a user input selecting one or a plurality of nodes displayed on the display being received, creating a channel for communication with another user equipment corresponding to the selected node.

According to various embodiments, a user equipment and a communication method of the present disclosure provide direct communication between a user equipment and an important user equipment or a target user equipment over a wider range.

### BRIEF DESCRIPTION OF THE DRAWINGS

FIGS. 1A, 1B, and 1C are views illustrating the number of cases of a mobile communication system according to an embodiment of the present disclosure;

FIG. 2 is a block diagram provided to explain the configuration of a user equipment according to an embodiment of the present disclosure;

FIG. 3 is a block diagram illustrating a network hierarchy for direct communication between equipments according to an embodiment of the present disclosure;

FIG. 4 is a view provided to explain initial discovery of a user equipment according to an embodiment of the present disclosure;

FIG. 5 is a view provided to explain an example embodiment of relay of a discovery message;

FIG. 6 is a view provided to explain another example embodiment of relay of a discovery message;

FIG. 7 is a view provided to explain broadcasting of a discovery message according to an embodiment of the present disclosure;

FIG. 8 is a block diagram illustrating an on-network architecture;

FIG. 9 is a block diagram illustrating an off-network architecture;

FIG. 10 is a flowchart provided to explain a relay method according to a first embodiment of the present disclosure;

FIG. 11 is a flowchart provided to explain a relay method according to a second embodiment of the present disclosure;

FIG. 12 is a flowchart provided to explain a relay method according to a third embodiment of the present disclosure;

FIG. 13 is a view provided to explain broadcasting of a discovery message according to another embodiment of the present disclosure;

FIG. 14 is a view provided to explain conditions for filtering a receiving of a discovery message according to an embodiment of the present disclosure;

FIG. 15 is a view provide to explain the number of cases of a direct communication system between equipments according to an embodiment of the present disclosure;

FIG. 16 is a view provided to explain a first communication scenario to which mobile communication between equipments is applied according to an embodiment of the present disclosure;

FIG. 17 is a view provided to explain a second communication scenario to which mobile communication between equipments is applied according to an embodiment of the present disclosure;

FIG. 18 is a view provided to explain a third communication scenario to which mobile communication between equipments is applied according to an embodiment of the present disclosure;

FIG. 19 is a view provided to explain a fourth communication scenario to which mobile communication between equipments is applied according to an embodiment of the present disclosure;

FIG. 20 is a view provided to explain a user interface screen according to an embodiment of the present disclosure; and

FIG. 21 is a flowchart provided to explain a communication method of a user equipment according to an embodiment of the present disclosure.

### DETAILED DESCRIPTION OF EXEMPLARY EMBODIMENTS

Hereinafter, an embodiment of the present disclosure will be described in detail with reference to the accompanying drawings. In the following description of the present disclosure, detailed description of known functions and configurations incorporated herein will be omitted when it may make the subject matter of the present invention rather unclear.

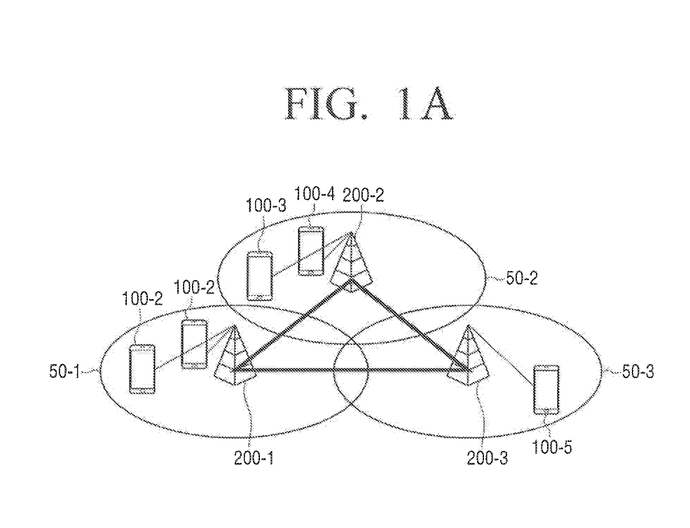

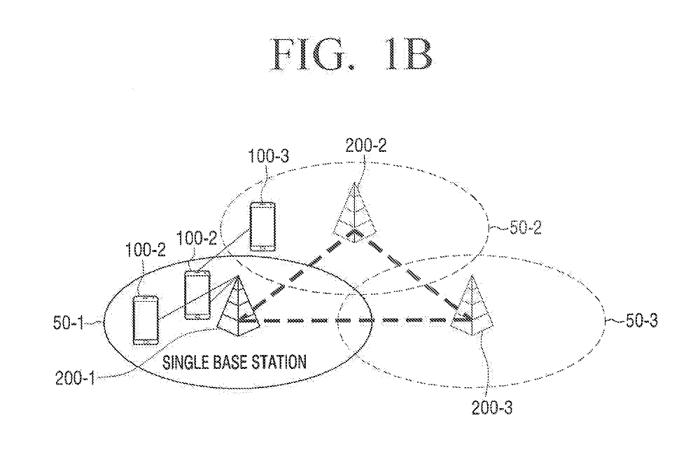

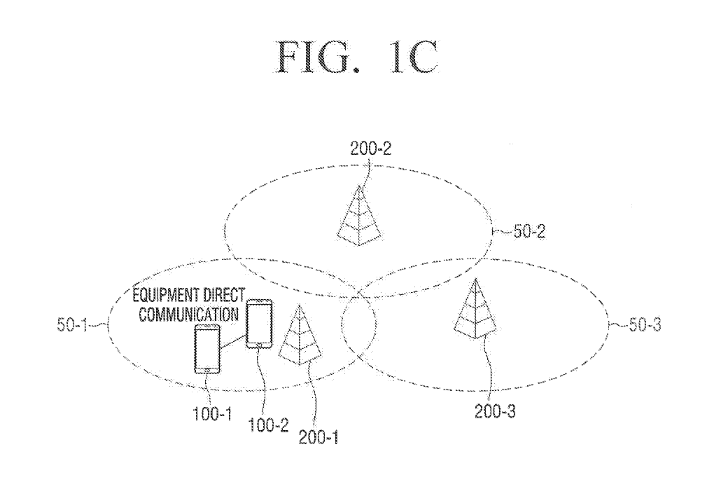

FIGS. 1A, 1B, and 1C are views illustrating the number of cases of a mobile communication system according to an embodiment of the present disclosure.

FIG. 1A is a view illustrating a mobile communication system in its normal operation. Referring to FIG. 1A, a mobile communication system may include user equipments 100-1, 100-2, 100-3, 100-4 and 100-5 and base stations 200-1, 200-2 and 200-3.

The base stations 200-1, 200-2 and 200-3 may communication with the user equipments 100-1, 100-2, 100-3, 100-4 and 100-5 within respective cells 50-1, 50-2 and 50-3 where communication is available. Specifically, the base station 200-1 may communicate with the user equipments 100-1 and 100-2 in the cell 50-1. The base station 200-2 may communicate with the user equipments 100-3 and 100-4 in the cell 50-2. The base station 200-3 may communicate with the user equipment 100-5 in the cell 50-3. The user equipments 100-1, 100-2, 100-3, 100-4 and 100-5 may communicate with one another through the base stations 200-1, 200-2 and 200-3 connected to a network although the user equipments 100-1, 100-2, 100-3, 100-4 and 100-5 are dispersedly located across the huge area.

FIG. 1B is a view illustrating that some of the base stations stop their operations in the mobile communication system of FIG. 1A. Referring to FIG. 1B, the base stations 200-2 and 200-3 may stop operating. Accordingly, the cells 50-2 and 50-3 where the base stations 200-2 and 200-3 that stop operating are located may change to non-communicable areas, i.e. shaded areas.

The user equipment 100-3 located in the non-communicable area may directly communicate with the user equipment 100-2 located in the area 50-1, which is a communicable area. The user equipment 100-3 may communicate with the user equipment 100-2 via D2D communication, access the base station 200-1 through the user equipment 100-2 connected to the base station and perform network communication.

FIG. 1C is a view illustrating that all the base stations stop operating in the mobile communication system of FIG. 1A. Referring to FIG. 1C, all the base stations 200-1, 200-2 and 200-3 may stop operating. That is, network communication is not available in all areas. The user equipments 100-1 and 1002 next to each other may perform communication only via direct communication between equipments.

The present disclosure suggests a method for setting direct communication between user equipments across the huge area when network communication is not established via a base station as shown in FIGS. 1B and 1C.

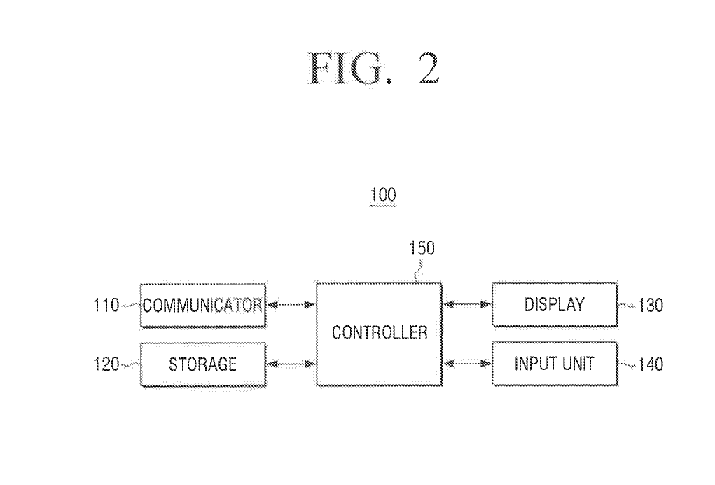

FIG. 2 is a block diagram provided to explain the configuration of a user equipment according to an embodiment of the present disclosure.

Referring to FIG. 2, a user equipment 100 may include a communicator 110, a storage 120, a display 130, an input unit 140 and a controller 150.

The communicator 110 may perform communication with an external apparatus. To be specific, the communicator 110 may perform wireless communication with another user equipment. The communicator 110 may comply with a communication method such as GSM EDGE Radio Access Network (GERAN), Universal Terrestrial Radio Access Network (UTRAN, normally referred to as 3G), Evolved-UTRAN (E-UTRAN, referred to as LTE), etc. according to mobile communication system standards.

The communicator 110 may broadcast a discovery message for informing another user equipment of the user equipment itself. To be specific, the communicator 110 may broadcast a discovery message for informing another user equipment nearby of the presence of the user equipment 100 or identifying another user equipment nearby. For reference, a discovery method may have two types in terms of relation between a user equipment itself and the other use equipment. A first model may be “I am here” method on the purpose of advertising a user equipment itself, and a second model may be “who is there” method for solicitation to another user equipment neighboring the user equipment and receiving a response accordingly. According to the first mode, the user equipment advertising itself may be referred to as an announcer, and the other user equipment that receives that advertisement may be referred to as a monitor. According to the second model, the user equipment that gives solicitation may be referred to as a discoverer, and the other user equipment that responds to the solicitation may be referred to as a discoveree.

The communicator 110 may receive a discovery message broadcast from another user equipment. Specifically, the communicator 110 may receive a message from another user equipment for notifying the another user equipment itself or a message for giving the solicitation for a response from the user equipment 100 neighboring the another user equipment.

The communicator 110 may include a transmitting/receiving antenna for transmitting and receiving one or a plurality of wireless signals, an amplifier for amplifying an electric signal, a module for channel decoding/encoding, modulation/demodulation and Fourier conversion/inversion, etc.

The communicator 110 may communicate with a base station device. The communicator 110 may obtain information necessary for filtering a discovery message through signaling with the base station device. The filtering may refer to extracting only the part of information needed from a plurality of received discovery messages, and the base station device may refer to information serving as a reference required for filtering.

The storage 120 may store programs and data for driving and operating the user equipment 100. The storage 120 may store the information obtained from the base station device through the communicator 110. Specifically, the storage 120 may store IDs of a plurality of user equipments constituting a group that receives service for direct communication between equipments. The ID may refer to identification information for distinctly identifying each user equipment in the group. The storage 120 may store status information given to respective stored IDs of a plurality of user equipments. The status information may indicate how important a user equipment is. The importance of a user equipment may be determined by a user of a user equipment when the user signed up for direct communication service between equipments. When one of members of a group signed up for direct communication service between equipments, the importance of the user equipment of the member may be determined by hierarchy between the members. In a general sense, a user equipment may be given status information corresponding to any one of a plurality of roles constituting the pre-arranged command system.

According to an embodiment, a ProSe application server (AS) managing direct communication between equipments may store status information corresponding to the position input as user information when a user equipment joins a group. The ProSe AS may distribute the ID and status information stored therein to user equipments in the group. The user equipment may store IDs and status information received from an upper node.

The storage 120 may store the segmented ratings of status information. Specifically, the storage 120 may store the ratings that indicates priorities of the status information. The priorities of the ratings may be used as criteria for selecting an ID to be relayed.

The storage 120 may be implemented with various non-temporary storage media. For example, the storage 120 may be a magnetic recording type HDD, a flip flop recording type SDD, a flash memory, an optical recording medium, or the like. The storage 120 may be embedded in a user equipment or connected via an interface.

The display 130 may display a screen. Specifically, the display 130 may provide a user with information and display a screen providing an interface for receiving a user input.

The display 130 may display change of the IDs and/or the status information stored in the storage 120. Specifically, the display 130 may display a screen to inform a user of IDs and/or status information renewed or added based on the information included in a discovery message or the information received from a base station.

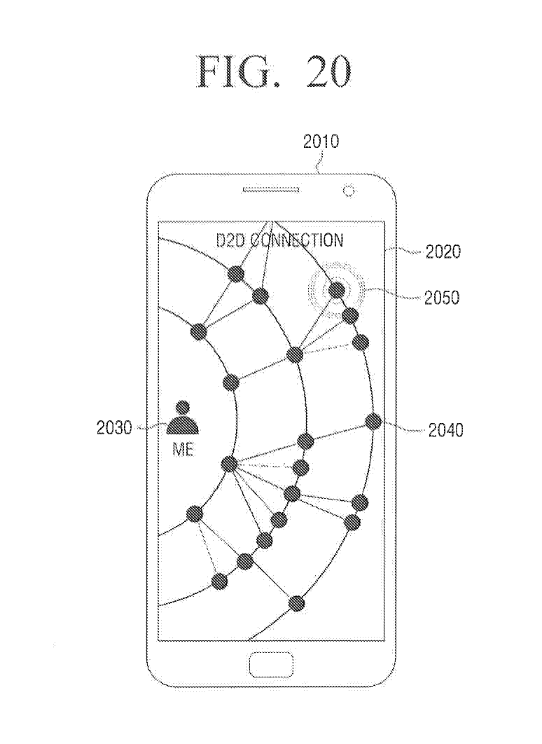

The display 130 may visually display a screen indicating a connection relation between the user equipment and another communicable user equipment. The display 130 may visually display a screen indicating the number of times of relays and paths through the connection to another user equipment based on the received discovery message. The display 130 may display a screen receiving a user input for communication connection to another user equipment. An example of an interface screen will described in detail with reference to FIG. 20.

The display 130 may be embodied with various display units such as liquid crystal display (LCD), organic light-emitting diode (OLED), plasma display (PD), vacuum fluorescent display (VFD), field emission display (FED), electro luminescence display (ELD), etc.

The input unit 140 may receive a user input. Specifically, the input unit 140 may be embodied with one or more of devices where various functions supported by the user equipment 100 is set or selected by a user. The input unit 140 may be embodied with a physical button member provided on the user equipment 100 or a touch panel detecting a touch. The touch panel may be embodied with a touch screen capable of inputting and outputting simultaneously with the display 130.

The controller 150 may control each element of the user equipment 100. The controller 150 may control each element of the user equipment 100 for mobile communication and D2D communication of the user equipment 100.

In response to at least one discovery message being received, the controller 150 may extract at least one ID of another user equipment from the received discovery message. The controller 150 may, if the communicator 110 receives a discovery message, extract one or a plurality of IDs included in a discovery message from another user equipment. The controller 150 may extract at least two IDs. One of the IDs may be the ID of another user equipment which broadcasts the received discovery message, and the other ID may be the ID of yet another user equipment relayed by the another user equipment.

The controller 150 may select at least one of the IDs extracted based on the status information. The controller 150 may select at least one of the IDs extracted based on the status information indicating the importance of another user equipment.

The controller 150 may retrieve status information corresponding to the extracted ID with reference to the IDs and the status information stored in the storage 120 and select an ID based on the retrieved status information. The controller 150 may determine whether the ID extracted based on the retrieved status information is an ID to be relayed to yet another user equipment.

The controller 150 may select at least one ID from the IDs extracted based on whether the status information given to another user equipment is status information corresponding to a role to be reported and ordered according to a command system. In the above example, each of user equipments of the members of a group may be given the corresponding status information. Based on the report from subordinate to superior and the order from the superior to the subordinate according to the hierarchy of the group, the user equipments may identify the user equipment of a member who is always needs to be communicated, i.e. a superior, based on the ID and the status information.

In response to a plurality of discovery messages being received, the controller 150 may determine the rating of each of the plurality of IDs extracted from the received plurality of discovery messages. The rating may be determined by the result retrieved from the storage 120 that stores the ID and rating of the user equipment of the group. The controller 150 may select an ID having a higher priority of the ratings among the plurality of extracted IDs as an ID for the relay.

The controller 150 may modify the rating stored in the storage 120 based on at least one of status information of another user equipment included in the received discovery message and status information of the user equipment itself. The controller 150 may modify the stored ratings based on the status information included in or detected by the discovery message informed of the change of the ratings. Modification of the ratings may be made when the group is reorganized, the senior is replaced, and the command is temporarily granted. The status information indicating such situation may be contained in a discovery message broadcasted from another user equipment.

The controller 150 may modify the ratings based on a state that enables communication via a network, a current time, integration with another group that is provided with service for direct communication between equipments, segmentation of groups of user equipments. For example, the controller 150 may give a higher ranting to an ID of a user equipment capable of network communication and indicate the user equipment as an important user equipment capable of UE-to-Network relay. If the identified present time passes to the night time or the identified present time is a distribution time, the controller 150 may give a higher ranting to a user equipment of a user given a particular task at that time. If the group to which the user belongs is a police agency and the police agency is integrated with the fire agency, the controller 150 may modify the ratings according to the hierarchy where status is added and changed in the integrated group.

The broadcast discovery message may be created in a packet of a limited size. The user equipment may not relay all the extracted IDs if the extracted plurality of IDs exceed a predetermined number.

In this aspect, the controller 150 may select IDs equal to or less than a predetermined number based on the determined ratings according to a size of a packet transmitted via a discovery message among the plurality of IDs. The controller 150 may create a discovery message by selecting IDs from the highest priority to the lowest priority.

When the part of a plurality of IDs on the same rating is selected, that is, when it is not possible to transmit all of the plurality of IDs on the same rating via a discovery message, the part of IDs that is to be contained in the packet of the size set based on the number of times each of the plurality of IDs is relayed. Specifically, the controller 150 may select IDs on the same rating from the smallest number of times of relays to the greatest number of times of relays. This is because the smaller number of times of relays of the IDs may ensure high quality communication until communication between equipments is established.

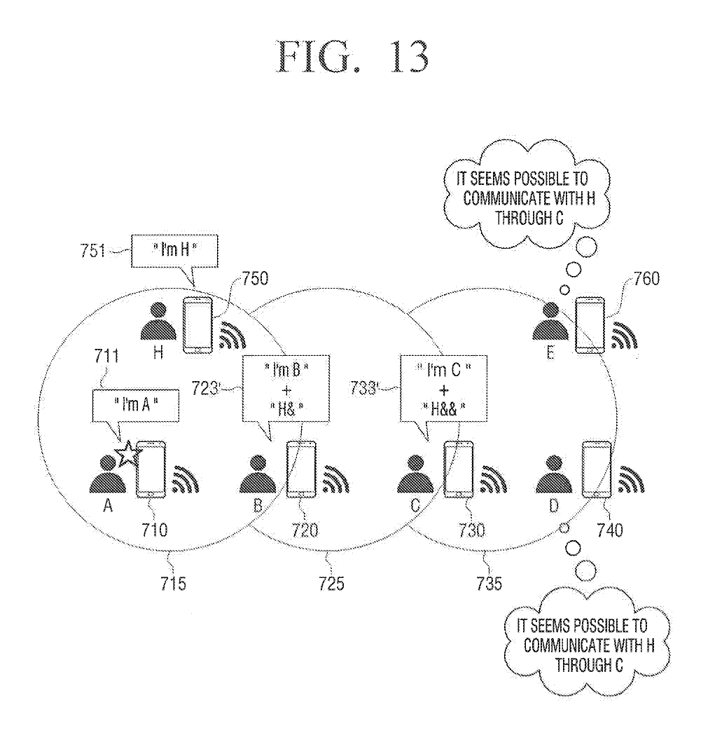

The controller 150 may broadcast a discovery message at a different period according to the ID rating. The controller 150 may not relay the same ID based on the status information, but broadcast a discovery message including an ID having a lower priority, which is not broadcasted, at a longer period. The detailed description thereof will be described below with reference to FIG. 13.

The received discovery message may include at least one ID of another user equipment and relay information indicating the number of times the ID is relayed. The controller 150 may include relay information indicating the number of times the ID of another user equipment is relayed in a discovery message including the ID of another user equipment, not the ID of the user equipment 100 itself.

The controller 150 may extract at least one ID of another user equipment and relay information indicating the number of times the ID is relayed from the received discovery message. The controller 150 may broadcast a discovery message including at least one ID selected from the extracted IDs based on the status information and relay information obtained by adding the number of times the selected ID is relayed once. That is, the controller 150 may add the number of times the user equipment 100 itself is relayed, once to the relay information.

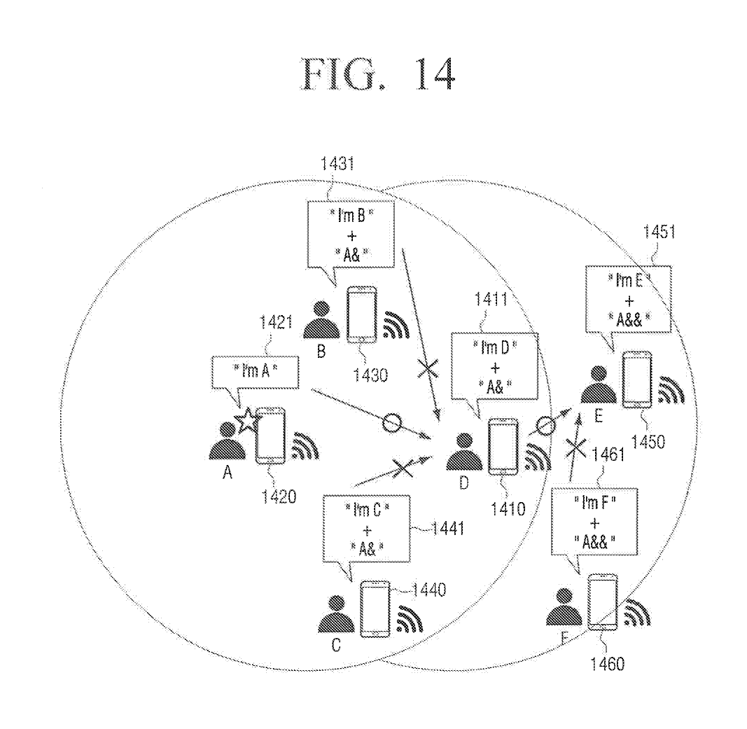

In response to a plurality of discovery messages including the same ID being received, the controller 150 may broadcast a discovery message including the same ID based on a discovery message including relay information indicating the fewest number of times of relays among the plurality of received discovery messages. Other user equipments near the user equipment 100 may store the same status information. The user equipment 100 may likely receive discovery messages including the same ID having a higher priority from other user equipments nearby. Therefore, the user equipment 100 may create a discovery message based on the number of times of relays and the smaller number of relay information. The controller 150 may correspond the received same ID to the ID of another user equipment relayed by the smaller number of times, and abandon the remaining IDs. The detailed description will be made below with reference to FIG. 14.

The controller 150 may create a D2D communication channel for direction communication between equipments. The controller 150 may create a one-to-one communication channel between a user equipment and another user equipment based on the ID of another user equipment discovered by the received discovery message. The controller 150 may transmit a signal for requesting connection to the user equipment of the selected ID for D2D communication to a user equipment which broadcasts the received discovery message. Another user equipment that receives a request signal may relay a signal that requests connection to another user equipment that broadcasts the selected ID for D2D communication based on the received discovery message.

The controller 150 may, in response to a user input selecting a node for indicating another user equipment displayed on the display 130 being received through the input unit 140, create a channel for communication with another user equipment corresponding to the selected node.

The controller 150 may include a Read-Only Memory (ROM) that stores a control program for controlling the CPU and the user equipment 100 and a Random Access Memory (RAM) that stores signals or data input from outside the user equipment 100 or is used as a storage area for a task performed by the user equipment 100. The CPU may include at least one of a single-core processor, a dual-core processor, a triple-core processor, and a quad-core processor. The CPU may be a mobile processor specialized for a handheld device. The processor, ROM and RAM may be interconnected via an internal bus.

The user equipment 100 may relay information that identifies a user equipment of an important user to another user equipment by using a discovery message of a limited size.

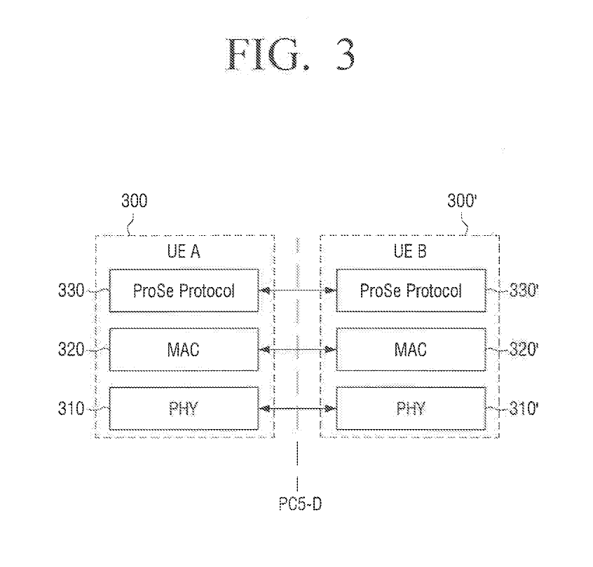

FIG. 3 is a block diagram illustrating a network hierarchy for direct communication between equipments according to an embodiment of the present disclosure.

Referring to FIG. 3, a user equipment UE A 300 and a user equipment UE B 300′ may support direct communication between equipments. The user equipment UE A 300 and the user equipment UE B 300′ both support the communication scheme of the E-UTRAN. A side link between the UEs may be generated via the PC5 interface by distinguishing the uplink and downlink between the eNB and the UE, both of which are upper nodes.

ProSe Protocol layers 330 and 330′ may transmit a discovery message to an Access Stratum (AS). That is, the ProSe Protocol layers 330 and 330′ may provide an interface with an upper layer.

The AS may consist of MAC layers 320 and 320′ and PHY layers 310 and 310′. The MAC layers 320 and 320′ may receive a discovery message from the ProSe Protocol layers 330 and 330′ and determine a radio resource for broadcasting the received discovery message. The MAC layers 320 and 320′ may build a Protocol Data Unit (PDU) created from a discovery message to be in a predetermined format, and transmit the MAC PDU to the PHY layer in order to transmit the PDU to the determined radio resource.

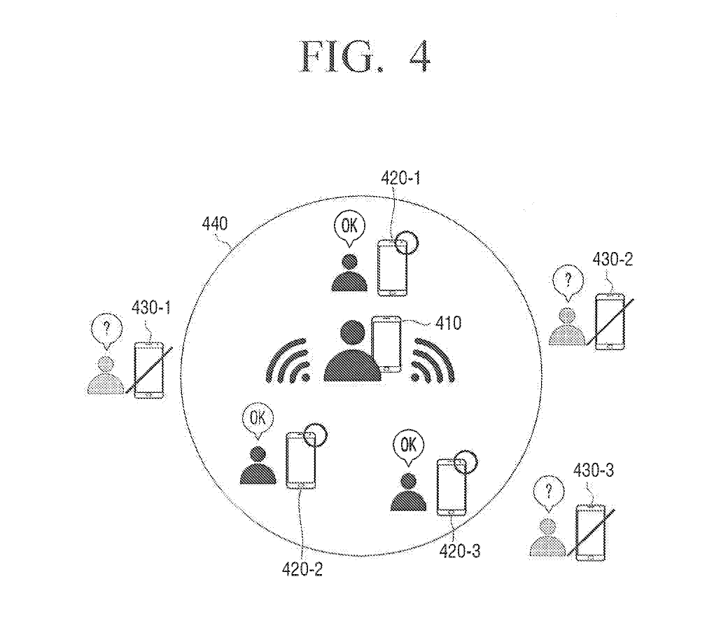

FIG. 4 is a view provided to explain initial discovery of a user equipment according to an embodiment of the present disclosure.

Referring to FIG. 4, a user equipment 410 and other user equipments 420-1, 420-2, 420-3, 430-1, 430-2, and 430-3 may be dispersedly located at different positions.

The user equipment 410 may broadcast a discovery message with a preset intensity of a signal. A range 440 to which a broadcast signal reaches from the user equipment 100 may be determined based on the intensity of a signal. The user equipment 410 may broadcast a discovery signal of stronger intensity than the intensity of a signal in communication with the base station.

The user equipments 420-1, 420-2 and 420-3 near the user equipment 410 may be located within a reachable range of a broadcasting signal. The user equipments 420-1, 420-2 and 420-3 may identify the presence of the user equipment 410. However, the user equipments 430-1, 430-2 and 430-3 out of the range 440 may not recognize the user equipment 410.

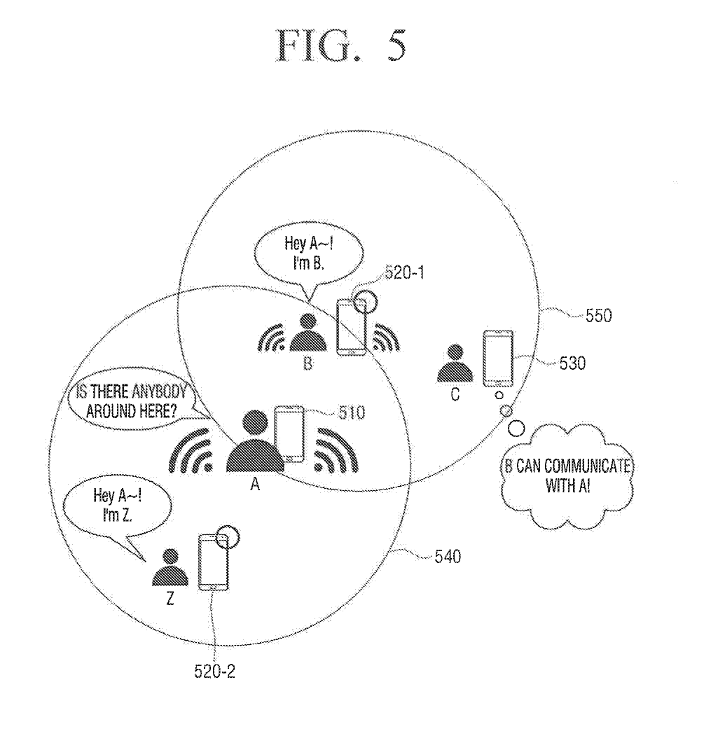

FIG. 5 is a view provided to explain an example embodiment of relay of a discovery message.

Referring to FIG. 5, a user equipment 510 of A may broadcast a discovery message “who is there?” of the second model. A user equipment 520-1 of B and a user equipment 520-2 of Z in the range 540 where a broadcast signal arrives may recognize the user equipment 510 of A, and broadcast a discovery message for informing a user equipment itself, which is including the IDs of the user equipments 520-1 and 520-2. A user equipment 530 of C may be within a range 550 where a broadcast signal of the user equipment 520-1 of B reaches. The user equipment 530 of C may identify that from the response signal broadcasted by the user equipment 520-1 of B that the user equipment 520-1 of B may communicate with the user equipment 510 of A. However, the user equipment 530 of C may not identify the presence of the user equipment 520-2 of Z.

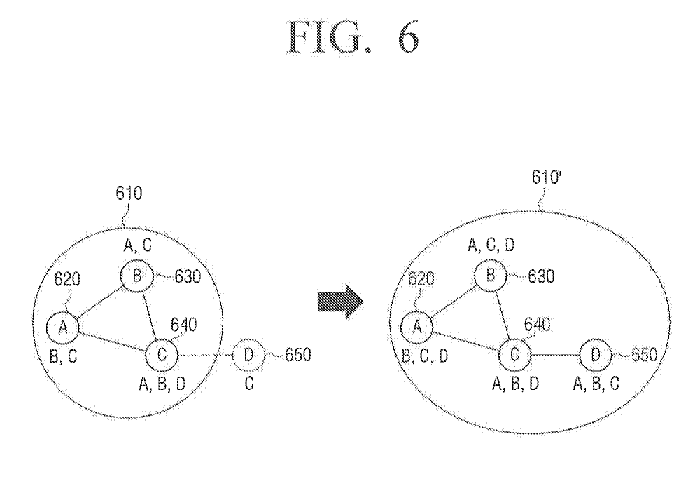

FIG. 6 is a view provided to explain another example embodiment of relay of a discovery message.

Referring to FIG. 6, a group network 610 of one to N may be formed. Specifically, a user equipment A 620, a user equipment B 630, and a user equipment C 640, which are next to one another, may form a 1:2 D2D network. The user equipment A 620, the user equipment B 630, and the user equipment C 640 each may store identification information of other user equipments to communicate with one another. That is, the user equipment A 620 may store IDs of the user equipment B 630 and the user equipment C 640, the user equipment B 630 may store IDs of the user equipment A 620 and the user equipment C 640, and the user equipment C 640 may store IDs of the user equipment A 620 and the user equipment B 630. The user equipment C 640 and a user equipment D 650 may recognize each other through a discovery procedure. The user equipment D 650 may directly communicate only with the user equipment C 640.

The user equipment C 640 may transmit identification information A and B of the user equipment A 620 and the user equipment B 630, which is communicated when the user equipment C 640 is relayed to the user equipment D 650. In the same manner, the user equipment C 640 may transmit identification information D of a new user equipment 650 that is communicated when the user equipment C 640 is relayed to the user equipment A 620 and the user equipment B 630 in the group. Consequently, a 1:3 group network 610′ may be newly formed.

As described above, transmitting identification information of all members in a group to a new network subscriber may be limited due to the size of a transmission message. Also, as the number of members in the group increases, the traffic for forming a network will increase in arithmetic progression.

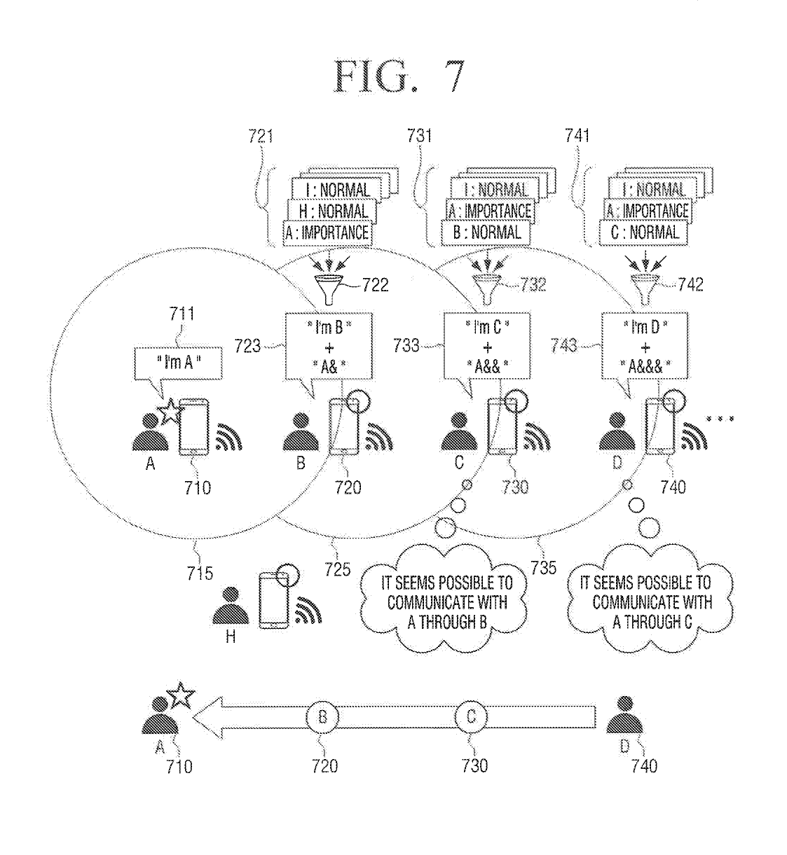

FIG. 7 is a view provided to explain broadcasting of a discovery message according to an embodiment of the present disclosure.

Referring to FIG. 7, a user equipment 710 of A may broadcast a discovery message “I am A” according to the first model. A user equipment 720 of B within a range 715 to which a broadcasting signal of the user equipment 710 of A reaches may receive a plurality of discovery messages 721 from another user equipment nearby.

The user equipment 720 of B may select an ID for relay from among IDs included in the received plurality of discovery messages 721 based on the status information. The ID for relay may be selected by a filter module 722. The filter module 722 may select A having a high priority as the ID for relay based on the stored status information or ratings.

The use equipment 720 of B may broadcast a discovery message including ‘A&’ that indicates the important member A is relayed for the first time. A user equipment 730 of C within the reach of the broadcasting signal of the user equipment 720 of B may receive a plurality of discovery messages 731 from other user equipments.

The user equipment 730 of C that receives a discovery message 723 of the user equipment 720 of B may recognize communication with the user equipment 710 of A through the user equipment 720 of B.

A filter module 732 of the user equipment 730 of C may select an ID for relay from among the plurality of extracted IDs. The user equipment 730 of C may broadcast a discovery message including ‘A&&’ indicative of relaying the important member A for the second time. A user equipment 740 of D within a range 735 to which a broadcast signal of the user equipment 730 of C reaches may receive a plurality of discovery messages from other user equipments.

The user equipment 740 of D that receives a discovery message 733 of the user equipment 730 of C may recognize communication with the user equipment 710 of A through the user equipment 730 of C.

A filter module 742 of the user equipment 740 of D may select an ID for relay from among the plurality of extracted IDs. The user equipment 730 of D may broadcast a discovery message including ‘A&&&’ indicative of relying the important member A for the third time.

The D may make a phone call to the user equipment 710 of A that is recognized through the discovery message relayed by using the user equipment 740. The user equipment 740 of D may transmit a signal to the user equipment 710 of A through the relay of the user equipment 730 of C and the user equipment 720 of B.

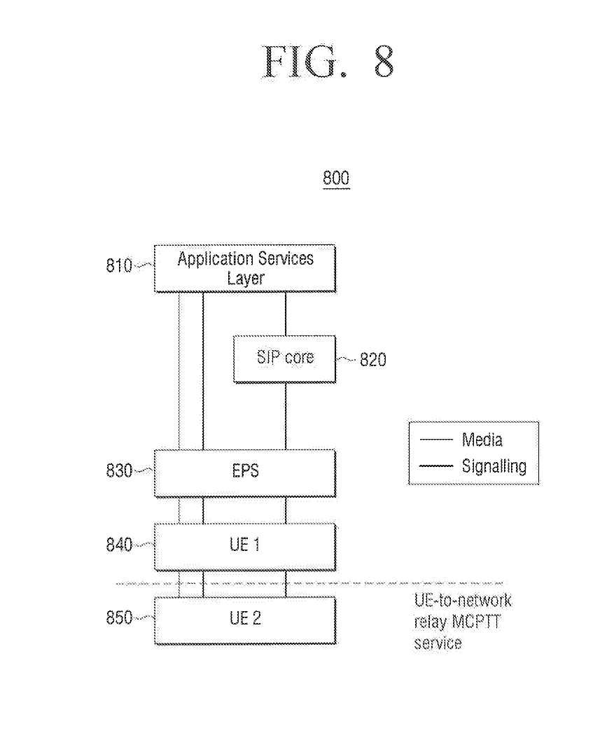

FIG. 8 is a block diagram illustrating an on-network architecture.

Referring to FIG. 8, a user equipment 1 840 may be connected to EPS 830 for providing MCPTT service through RAN interface (Uu or Um) in an on state where a network of an upper node operates normally. The MCPTT may stand for Mission Critical Push-to-Talk and refer to service that provides direct call between UEs using the LTE method for disaster safety communication. The Evolved Packet System (EPS) 830 may include a Home Subscriber Server (HSS), a Mobile-services Switching Center (MSC), a Mobility Management Entity (MME), and Gateways (GW).

An MCPTT application service 810 may include an MCPTT server consisting of a configuration management server, a group management server, an identity management server, a floor control server, etc. The configuration management server may configure data of an MCPTT client device. This configuration management server may manage MCPTT service configuration supported by an MCPTT service provider. A group management server may manage the groups supported by the MCPTT service provider.

Client devices included a single group may use the same group management server for the group. An identification management server may authenticate an MCPTT user. That is, the identification management server may include authentication means for confirming credentials of a user. A floor control server may control access for the use and sharing of resources of a plurality of users. The MCPTT server may track the MCPTT UE, allocate resources, control transmission of the uplink and the downlink of the media, and the like.

An SIP core 820 may provide rendezvous (combination of contact addresses and URI determination) and service control (application service selection) functions.

The user equipment UE 1 840 may support bearer services and applications associated with MCPTT. The user equipment UE 1 840 may also function as a relay node of the UE-to-Network relay. The user equipment UE 1 840 may be directly connected to a user equipment UE 2 850 to relay network communication of the user equipment UE 2 850.

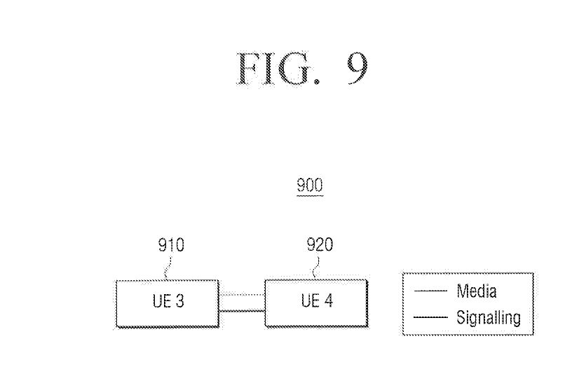

FIG. 9 is a block diagram illustrating an off-network architecture.

Referring to FIG. 9, a user equipment 3 910 may be connected to a user equipment 4 920 in a state where a network on an upper node is off. The user equipment 3 910 and the user equipment 4 920 may use ProSe technology and support an application regarding the off-network MCPTT service.

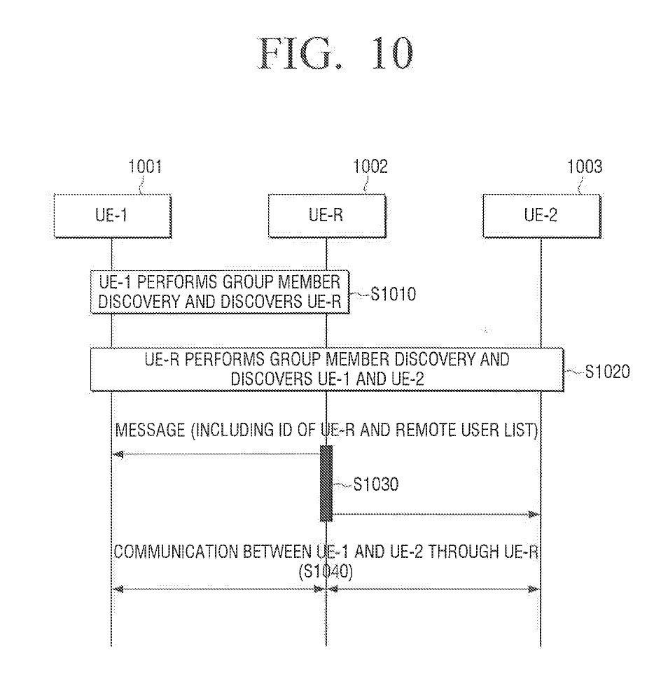

FIG. 10 is a flowchart provided to explain a relay method according to a first embodiment of the present disclosure.

Referring to FIG. 10, a user equipment UE-1 1001 may perform group member discovery at step S1010. The user equipment UE-1 1001 may broadcast a discovery message in a first mode or a second mode. The discovery message may not be for a specific UE but may be a message for searching for all the neighboring members in the group to which the user equipment UE-1 1001 belongs. The user equipment UE-1 1001 may discover a user equipment UE-R 1002 which is one of group members. The user equipment UE-R 1002 that receives a discovery message of the user equipment UE-1 1001 may recognize the presence of the user equipment UE-1 1001 nearby. For convenience of explanation, it is assumed that the user equipment UE-1 1001 is given important status information.

The user equipment UE-R 1002 may perform group member discovery at step S1020. The user equipment UE-R 1002 may broadcast its own discovery message. The user equipment UE-R 1002 that performs discovery may discover user equipments nearby such as the user equipment UE-1 1001 and the user equipment UE-2 1003.

The user equipment UE-R 1002 may broadcast a message including a remote user list where an ID of a user equipment to which important status information is given is sorted out among the discovered user equipments at step S1030. The user equipment UE-R 1002 may transmit a message including the ID of the user equipment UE-1 1001 and the ID of the user equipment UE-R 1002 itself to the user equipment UE-2 1003. The user equipment UE-2 1003 may recognize the presence of the user equipment UE-1 1001 which is communicable through the user equipment UE-R 1002.

The user equipment UE-1 1001 and the user equipment UE-2 1003 may perform communication through the relay of the user equipment UE-R 1002 at step S1040.

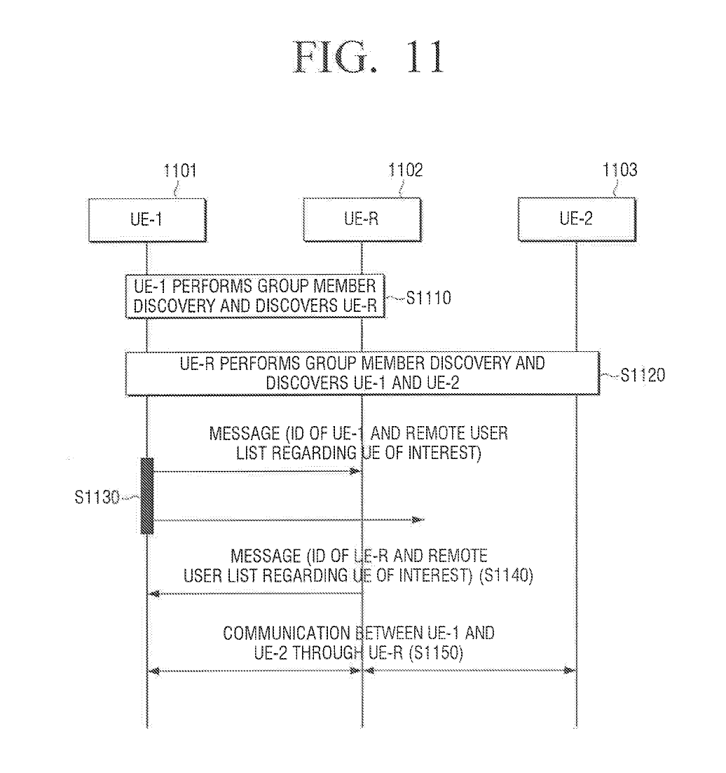

FIG. 11 is a flowchart provided to explain a relay method according to a second embodiment of the present disclosure.

Referring to FIG. 11, a user equipment UE-1 1101 may perform group member discovery at step S110. A user equipment UE-R 1102 may perform group member discovery at step S1120. Steps S1110 and S1120 may correspond to steps S1010 and S1020 of FIG. 10. Therefore, the detailed description will be omitted.

The user equipment UE-1 1101 discovered by the discovery of the user equipment UE-R 1102 may broadcast a message including a remote user list where the ID of the user equipment UE-1 1101 and the IDs of user equipments UEs of interest at step S1130. A broadcasting signal of the user equipment UE-1 1101 may not reach the user equipment UE-2 1103.

In response to a message of the user equipment UE-1 1101 received at step S1130, the user equipment UE-R 1102 may transmit the ID of interest of the user equipment UE-1 1101 in the remote user list to the user equipment UE-1 1101 at step S1140.

The user equipment UE-1 1101 that recognizes the presence of the user equipment UE-2 1103 of its interest may perform communication with the user equipment UE-2 1103 through the user equipment UE-R 1102 at step S1150.

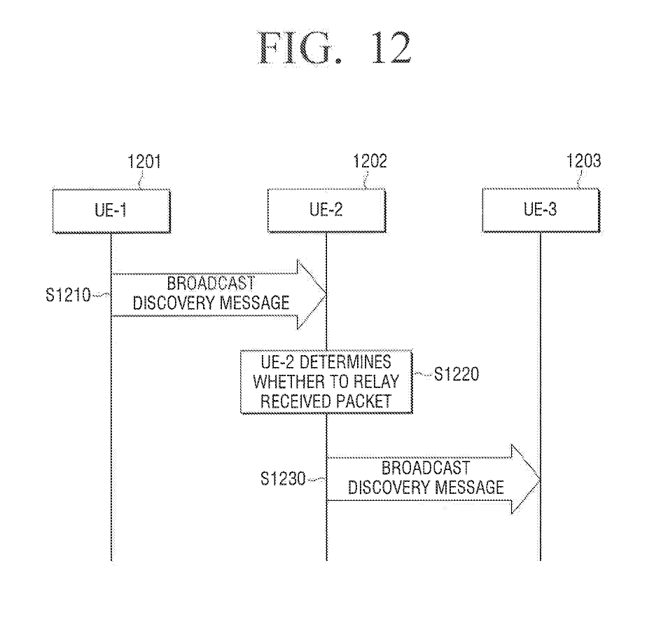

FIG. 12 is a flowchart provided to explain a relay method according to a third embodiment of the present disclosure.

Referring to FIG. 12, the user equipment UE-1 1201 may broadcast a discovery message at step S1210. The user equipment UE-2 1202 that receives a discovery message may determine whether the received packed needs to be relayed at step S1220. The UE-2 1201 may select an ID that needs to be relayed from the IDs included in a discovery message packet of the user equipment UE-1 1201 based on the status information.

The user equipment UE-2 1201 may broadcast a discovery message including the ID of the user equipment UE-1 1201 to which important status information is given at step S1230. The user equipment UE-3 1203 that receives a broadcasting signal of the user equipment UE-2 1201 may recognize the presence of the user equipment UE-1 1201 through the user equipment UE-2 1202.

FIG. 13 is a view provided to explain broadcasting of a discovery message according to another embodiment of the present disclosure.

Referring to FIGS. 13 and 7, FIG. 13 may include the user equipments 710, 720, 730 and 740 of FIG. 7. A user equipment 750 of H within the range 715 where the broadcasting signal of the user equipment 710 of A reaches and a user equipment 760 of E within the range 735 where the broadcasting signal of the user equipment 730 of C reaches may be further added.

According to a relay method of FIG. 7, the user equipment 720 of B may relay only the ID ‘A’ to which important status is given according to the status information. The user equipment 750 of H may broadcast a discovery message including “I am H”, but the user equipments 730, 740 and 760 of C, D and E out of the range of reach may not recognize the user equipment 750 of H.

The user equipment 720 of B may relay a discovery message 723′ including ‘H’ at predetermine periods although the rating of status information given to ‘H’ is lower than that of ‘A’. The user equipment 720 of B may temporarily raise the rating of ‘H’ or give a temporary status. The user equipment 720 of B may then broadcast the discovery message 723′ that includes relay information ‘H&’ and status information on the rating of ‘B’ temporarily raised or temporary status.

The user equipment 730 of C that receives the discovery message 723′ may broadcast a discovery message 733′ including ‘H&&’ according to the rating raised by the status information or the temporary status.

The user equipment 740 of D that receives the discovery message 733′ and the user equipment 760 of E may obtain information for accessing the user equipment 750 of H through the user equipment 730 of C.

FIG. 14 is a view provided to explain conditions for filtering a receiving of a discovery message according to an embodiment of the present disclosure.

Referring to FIG. 14, a user equipment 1410 of D may receive a plurality of discovery messages 1421, 1431 and 1441 from a plurality of other user equipments 1420, 1430 and 1440. Referring to the received plurality of discovery messages 1421, 1431 and 1441, the IDs of the user equipments as broadcasting sources may be different from one another by ‘A’, ‘B’ and ‘C’, but the ID to be relayed may be the same as ‘A’ to which status information of importance is given.

The user equipment 1410 of D may create a discovery message 1411 based on a discovery message including relay information indicating the fewest number of times of relays from among a plurality of discovery messages including the same ID ‘A’. The user equipment 1410 of D may extract the relay information from the plurality of discovery messages and identify what the discovery message having the smallest number of times of relays of ‘A’ is. In FIG. 14, a discovery message 1421 for informing a user equipment 1420 itself may have the smallest number of times of relays. The user equipment 1410 of D may broadcast a discovery message 1411 that includes “I am D” for informing the user equipment 1410 itself and the ‘A&’ indicating that the ID is relayed once based on the discovery message 1421.

In the same manner, a user equipment 1450 of E may receive a plurality of discovery messages 1411 and 1461 including ‘A’. The user equipment 1450 of E may reject the discovery message 1461 and broadcast a discovery message 1451 including ‘D’ as a broadcasting source and ‘A&&’ indicating that the ID is relayed twice based on the discovery message 1411 having the fewest number of times of relays.

The relay method of a discovery message allows a user equipment that receives a message to recognize the shortest path.

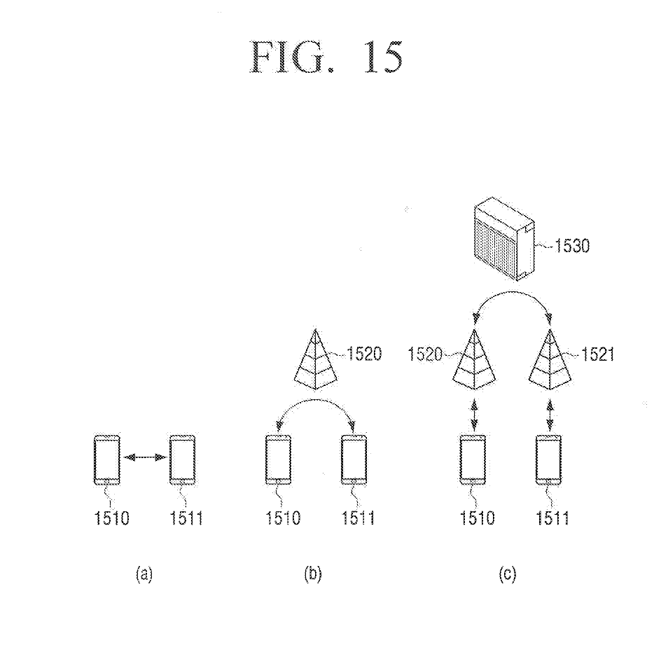

FIG. 15 is a view provide to explain the number of cases of a direct communication system between equipments according to an embodiment of the present disclosure.

FIG. (A) shows user equipments 1510 and 1511 that support direct communication between equipments may directly broadcast and receive a discovery message. As shown in FIGS. 15(B) and 15(C), the transmission and relay of a discovery message may be through upper nodes 1520, 1521 and 1530. FIG. 15(B) shows that a discovery message may be transmitted and received by the base station 1520 that is disconnected to a network but performs a relay function. FIG. 15C shows that a discovery message may be transmitted and received by a gateway 1530 that is disconnected to a network but performs a relay function between the base stations 1520 and 1521.

Such the relay of an upper node may expand the range of broadcasting a discovery message of a user equipment beyond a macro cell range.

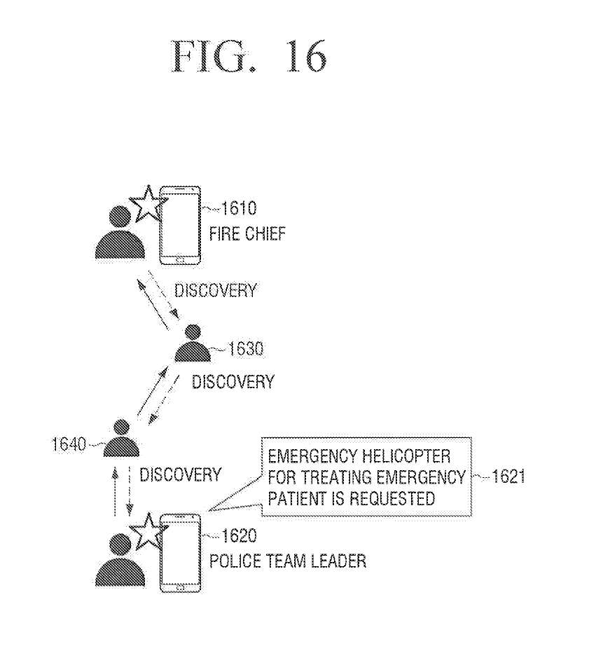

FIG. 16 is a view provided to explain a first communication scenario to which mobile communication between equipments is applied according to an embodiment of the present disclosure.

The staffs of the fire agency and the staffs of the police agency involved in a disaster site may include a fire chief and a police chief to manage the disaster. The ID of a user equipment 1610 of the fire chief may be given status information corresponding to the role of the fire chief in accordance with the organization structure of a command system to manage the disaster site. The ID of a user equipment 1620 of the police chief may be given status information corresponding to the role of the police chief.

The user equipment 1610 of the fire chief and the user equipment 1620 of the police chief may broadcast a discovery message including its respective ID. However, the user equipments 1610 and 1620 may be at a distance where a broadcasting signal is not directly detected.

User equipments 1630 and 1640 each may relay a discovery message at a distance close to the user equipment 1610 of the fire chief and the user equipment 1620 of the police chief.

Since the relay helps recognize the presence of the user equipments and the communicable paths, the police chief may make a phone call for requesting a helicopter to the fire chief by using the user equipment 1620.

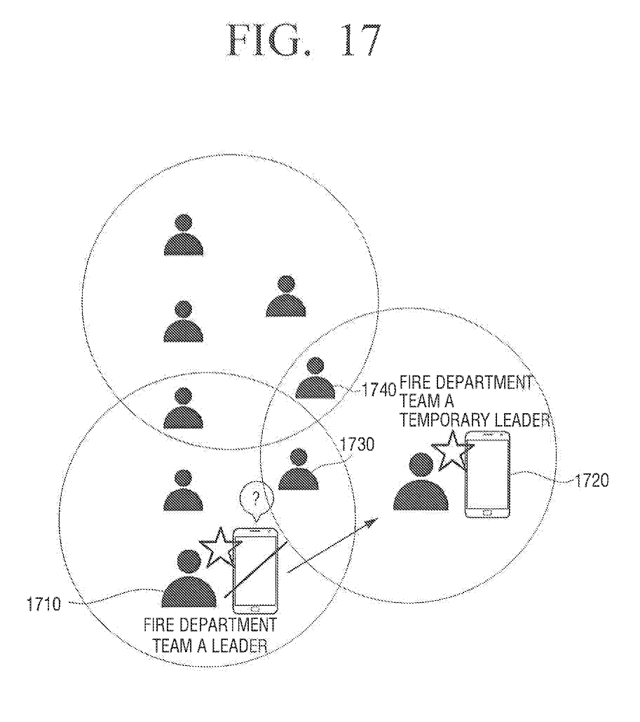

FIG. 17 is a view provided to explain a second communication scenario to which mobile communication between equipments is applied according to an embodiment of the present disclosure.

Referring to FIG. 17, members of the fire department team A may be dispersedly located across the huge disaster area. A leader 1710 of the fire department team A in charge of the operations may not be available. As a result, a member 1720 having a higher rank may be determined as a temporary leader of the fire department team A.

Such situation may lead to modification of the ratings given to the IDs. Specifically, the user equipment of the temporary leader 1720 of the fire department team A may broadcast a discovery message including an ID, a state where a temporary leader is assigned, and status information corresponding to a leader. The broadcasted discovery message may also be transmitted to a user equipment in a range where the signal broadcasted from the user equipment of the temporary leader 1720 does not reach by the relays of user equipments of the other members 1730 and 1740.

The user equipment which receives a discovery message may modify the rating corresponding to the ID of the user equipment of the temporary leader 1720 to the rating corresponding to a user equipment of a leader.

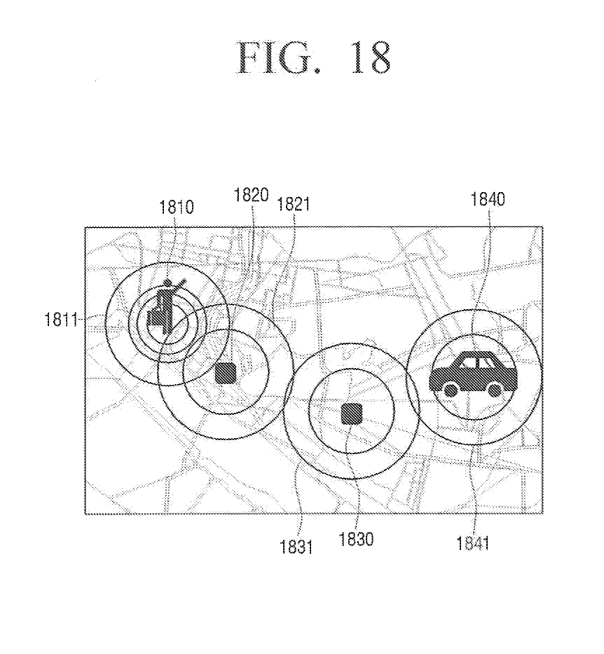

FIG. 18 is a view provided to explain a third communication scenario to which mobile communication between equipments is applied according to an embodiment of the present disclosure.

Referring to FIG. 18, a user 1810 may call a taxi without accessing a network. The user equipment of the user 1810 may gradually increase the intensity of a broadcasting signal 1811 and broadcast a message for searching for a taxi nearby.

User equipments 1820 and 1830 that receive broadcasting signals of the user equipment of the user 1810 may relay discovery messages through respective broadcasting signals 1821 and 1831.

An equipment device of a taxi 1840 may receive the relayed discovery message of a user 1811. The equipment device of the taxi 1840 may transmit a response message including the position of the taxi 1840 to the user equipment 1830 for the user 1810. The response message of the equipment device of the taxi 1840 may be transmitted to the user equipment of the user 1810 through the relays of the user equipments 1820 and 1830. By repeating the above procedure, the user 1810 may recognize the taxi 1840 at the shortest distance from the user 180 and at which exact position the taxi 1840 is located. The user 1810 may make a phone call to a taxi driver and inform the taxi driver of the place and time to take a taxi.

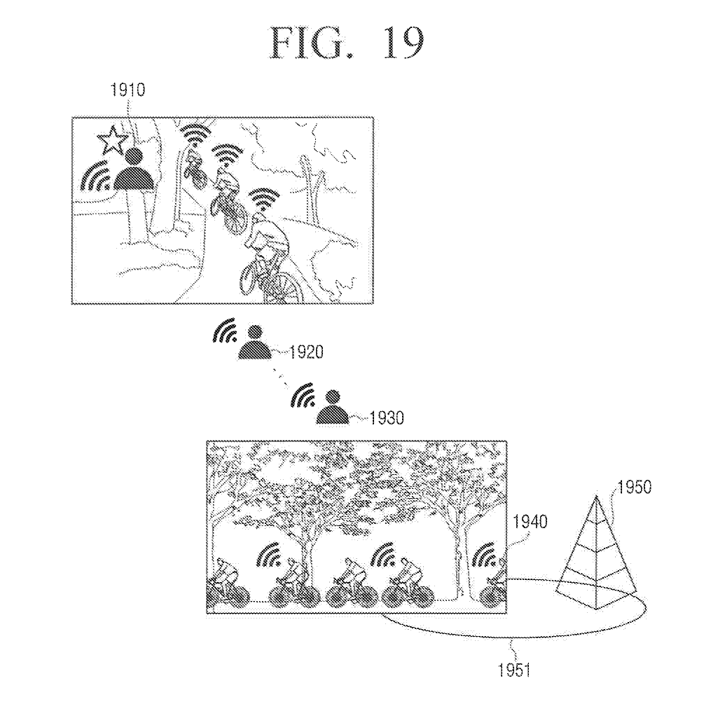

FIG. 19 is a view provided to explain a fourth communication scenario to which mobile communication between equipments is applied according to an embodiment of the present disclosure.

Referring to FIG. 19, a large-scale mountain bike crew may move toward the shaded mountain. There is a leader 1910 in crew. Some part of the crew members 1940 may still be a cell phone coverage 1951.

The ID of a user equipment of the leader 1910 ahead of all members may be distributed to user equipments of crew members by the broadcasting of the discovery message and the relay of the discovery message by other user equipments 1920 and 1930 located in the middle. The ID of a user equipment that is connectable to a base station 1950 and located at the back may also be distributed to the user equipments of the crew members by the broadcasting of the discovery message and the relay of the discovery message by the user equipments 1920 and 1930.

FIG. 20 is a view provided to explain a user interface screen according to an embodiment of the present disclosure.

Referring to FIG. 20, a user equipment 2010 may display a user interface screen 2020. The user interface screen 2020 may include graphic objects indicating the user equipment 2010 and other user equipments. The user interface screen 2020 may include a plurality of concentric circles based on a route 2030 indicating the user equipment 2010. The user interface screen 2020 may include nodes 2040 indicating other user equipments along the circumferences of the plurality of concentric circles. Nodes corresponding to other user equipments capable of communication without relay may be arranged on the circumference closest to the route 2030. On the next circumference, nodes corresponding to other user equipments capable of communication after one relay may be arranged. On the following circumference, nodes corresponding to other user equipments capable of communication after two relays may be arranged.

Nodes located on three circumferences may be connected through bridges indicating communicable relations. The bridge may show a path all the way through to a node for communication.

A user may select a node 2050 displayed on the interface screen 2020 by touching. The user equipment 2010 may transmit a request message for communication connection to the neighboring user equipment which is relayed to another user equipment corresponding to the node 2050 selected by the user.

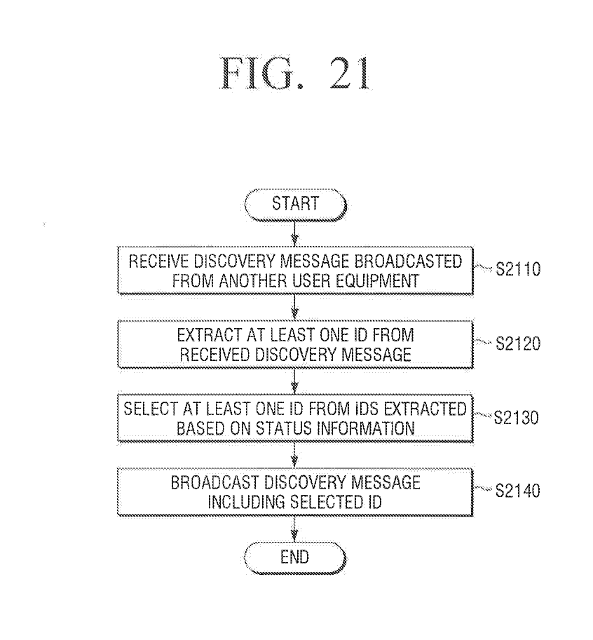

FIG. 21 is a flowchart provided to explain a communication method of a user equipment according to an embodiment of the present disclosure.

Referring to FIG. 21, a user equipment may receive at least one discovery message from another user equipment at step S2110. A user equipment may receive broadcasting of a discovery message created for informing another user equipment itself and relaying discovery messages of other neighboring user equipments from another user equipment.

At least one ID may be extracted from the received discovery message at step S2120. The user equipment may extract at least one ID, for example, the ID of another user equipment or the relayed ID from one or a plurality of discovery messages broadcasted from another user equipment.

At least one ID may be selected from the IDs extracted based on the status information at step S2130. The user equipment may select at least one ID from the IDs extracted based on the status information indicating importance of another user equipment.

The discovery message including the selected ID may be broadcasted at step S2140. The user equipment may broadcast a discovery message for relaying the ID of the important user equipment selected based on the status information.

The above communication method may further include storing IDs of user equipments constituting a group which is provided with service for direct communication between equipments and status information given to the IDs, and selecting at least one ID from the IDs extracted by retrieving the stored status information.

The status information may be represented by ratings indicating priorities, and the ID having a highest priority may be selected from among the plurality of IDs extracted based on the ratings.

The broadcasted discovery message may further include relay information indicating the number of times the ID is relayed. The communication method may further include extracting relay information, adding the number of times of relays as once, and relaying a discovery message including the ID.

The communication method may further include visually displaying nodes representing one or a plurality of user equipments that relay the extracted ID and bridges representing paths the extracted ID is relayed, and in response to a user input selecting one or a plurality of nodes displayed on the display being received, creating a channel for communication with another user equipment.

The communication method according to an embodiment of the present disclosure may relay information for identifying a user equipment of an important user to another user equipment by using a discovery message of a limited size. The communication method may be implemented on a user equipment having the configuration of FIG. 2, or on other communicable devices.

While the present disclosure has been described that all elements of an embodiment are coupled to one another or operate in combination, it is to be understood that the present disclosure is not limited to the disclosed embodiments. That is, within the scope of the present disclosure, all of the elements may be selectively coupled to one another in one or more of combinations. In addition, although all of the elements may be implemented as one independent hardware, some or all of the elements may be selectively combined to embody as a computer program including a program module performing a part or all of the functions in one or a plurality of hardware. The codes and code segments that constitute a computer program may be easily deduced by those skilled in the art. Such a computer program may be stored in a non-transitory computer readable medium readable by a computer, readable and executed by a computer, thereby realizing an embodiment of the present disclosure.

The non-transitory readable recording medium may not be a medium for storing data for a short time such as a register, a cache, a memory, etc., but mean a medium that semi-permanently stores data and is readable by a device. Specifically, the above-described programs may be stored in non-volatile readable recording media such as CD, DVD, hard disk, Blu-ray disk, USB, memory card, ROM, etc.

Although exemplary embodiments have been shown and described, it will be appreciated by those skilled in the art that changes may be made to these exemplary embodiments without departing from the principles and spirit of the present disclosure. Accordingly, the scope of the present disclosure is not construed as being limited to the described exemplary embodiments, but is defined by the appended claims as well as equivalents thereto.

What is claimed is:

1. A user equipment that supports direct communication between equipments, comprising:
a communicator configured to:
broadcast a discovery message for informing another user equipment of the user equipment itself, and
receive a discovery message broadcasted from another user equipment; and
a controller configured to:
in response to at least one discovery message being received, extract at least one identification (ID) of another user equipment from the at least one received discovery message,
select at least one ID from the at least one extracted ID based on status information indicating importance of the another user equipment, and
broadcast a discovery message including the at least one selected ID.

2. The user equipment as claimed in claim 1, further comprising:
a storage configured to store IDs of a plurality of user equipments constituting a group which is provided with service for the direct communication between equipments and status information respectively given to the IDs,
wherein the controller is further configured to:
retrieve status information given to the at least one extracted ID in the storage, and
select at least one ID from the at least one extracted ID based on the retrieved status information.

3. The user equipment as claimed in claim 1,
wherein the another user equipment is given status information corresponding to one of a plurality of roles constituting a pre-arranged command system, and
wherein the controller is further configured to select at least one ID from the at least one extracted ID based on whether the status information given to the another user equipment is status information corresponding to a role to be reported and ordered according to the command system.

4. The user equipment as claimed in claim 2,
wherein the storage is further configured to store ratings that indicate priorities of the status information given to the IDs, and
wherein the controller is further configured to:
in response to receiving a plurality of discovery messages,
determine ratings of respective IDs extracted from the plurality of received discovery messages, and
select at least one ID from the extracted IDs according to priorities of the determined ratings.

5. The user equipment as claimed in claim 4, wherein the controller is further configured to modify the ratings stored in the storage based on at least one of status information of the another user equipment included in the received discovery message and status information of the user equipment itself.

6. The user equipment as claimed in claim 5, wherein the controller is further configured to modify the ratings stored in the storage based on a state which enables communication via a network, a present time, integration with another group which is provided with the service for direct communication between equipments, and group division of the user equipments.

7. The user equipment as claimed in claim 4, wherein the controller is further configured to broadcast a discovery message including another ID which is not broadcasted among the plurality of IDs at different periods according to the determined ratings.

8. The user equipment as claimed in claim 4, wherein the controller is further configured to:
select IDs equal to or less than a predetermined number according to a size of a packet that is transmittable through the discovery message among the plurality of IDs based on the determined ratings, and
in response to all of a plurality of IDs on a same rating not being transmitted through the discovery message, select a number of IDs which are transmittable through the discovery message based on a number of times each of the plurality of IDs on the same rating is relayed.

9. The user equipment as claimed in claim 1, wherein the controller is further configured to:
extract at least one ID of another user equipment and relay information indicating a number of times the at least one ID is relayed from the received discovery message,
broadcast a discovery message including at least one ID selected from the at least one extracted ID based on the status information and relay information obtained by adding a number of times the at least one selected ID is relayed, and
in response to a plurality of discovery messages including the same ID being received, broadcast a discovery message including the same ID based on a discovery message including relay information that indicates a fewest number of times of relays among the plurality of received discovery messages.

10. The user equipment as claimed in claim 9, further comprising:
a display configured to display a screen; and
an input unit configured to receive a user input,
wherein the controller is further configured to:
display nodes indicating one or a plurality of user equipments which relay the at least one extracted ID and bridges indicating paths where the at least one extracted ID is relayed visually on the display, and
in response to a user input selecting one or a plurality of nodes displayed on the display being received, create a channel for communication with another user equipment corresponding to the selected node.

11. A communication method of a user equipment that supports direct communication between equipments, the method comprising:
receiving at least one discovery message broadcasted from another user equipment;
extracting at least one ID of another user equipment from the at least one received discovery message;
selecting at least one ID from the at least one extracted ID based on status information indicating importance of the another user equipment; and
broadcasting a discovery message including the at least one selected ID.

12. The method as claimed in claim 11, further comprising:
storing IDs of a plurality of user equipments constituting a group which is provided with service for direct communication between equipments and status information respectively given to the IDs,
wherein the selecting comprises:
retrieving status information given to the at least one extracted ID, and
selecting at least one ID from the at least one extracted ID based on the retrieved status information.

13. The method as claimed in claim 11,
wherein the another user equipment is given status information corresponding to one of a plurality of roles constituting a pre-arranged command system, and
wherein the selecting comprises selecting at least one ID from the at least one extracted ID according to whether the status information given to the another user equipment is status information corresponding to a role to be reported and ordered according to the command system.

14. The method as claimed in claim 12,
wherein the storing comprises storing ratings that indicate priorities of the status information given to the IDs, and
wherein the selecting comprises:
in response to a plurality of discovery messages being received, determining ratings of respective IDs extracted from the plurality of received discovery messages, and
selecting at least one ID from the extracted IDs according to priorities of the determined ratings.

15. The method as claimed in claim 1,
wherein the extracting comprises extracting at least one ID of another user equipment and relay information indicating a number of times the at least one extracted ID is relayed from the received discovery message, and
wherein the broadcasting comprises:
broadcasting a discovery message including at least one ID selected from the at least one extracted ID based on the status information and relay information obtained by adding a number of times the at least one selected ID is relayed, and
in response to a plurality of discovery messages including the same ID being received, broadcasting a discovery message including the same ID based on a discovery message including relay information that indicates a fewest number of times of relays among the plurality of received discovery messages.
